(19) United States
(12) Patent Application Publication
(10) Pub. No.: US 2009/0289856 A1
(43) Pub. Date: Nov. 26, 2009

(54) FILM TYPE ANTENNA AND MOBILE COMMUNICATION TERMINAL

(75) Inventors: Sung Eun CHO, Suwon (KR); Jae Suk Sung, Yongin (KR); Ha Ryong Hong, Hwaseong (KR); Kyong Keun Lee, Suwon (KR); Dae Seong Jeon, Suwon (KR); Chan Gwang An, Suwon (KR); Hyun Kil Nam, Seoul (KR)

Correspondence Address: LOWE HAUPTMAN HAM & BERNER, LLP, 1700 DIAGONAL ROAD, SUITE 300, ALEXANDRIA, VA, 22314, US

(73) Assignee: Samsung Electro-Mechanics Co., Ltd., Suwon (KR)

(21) Appl. No.: 12/245,999

(22) Filed: Oct. 6, 2008

(30) Foreign Application Priority Data
May 23, 2008 (KR) 10-2008-0048156

(51) Int. Cl. H01Q 1/38; H01Q 1/24

(52) U.S. Cl. 343/702; 343/700 MS

(57) ABSTRACT

There is provided a film type antenna including: a carrier film; a conductive pattern provided on one surface of the carrier film; and a conductive buffer layer provided on one surface of the conductive pattern.

### CROSS-REFERENCE TO RELATED APPLICATIONS

This application claims the priority of Korean Patent Application No. 2008-0048156 filed on May 23, 2008, in the Korean Intellectual Property Office, the disclosure of which is incorporated herein by reference.

### BACKGROUND OF THE INVENTION

1. Field of the Invention

The present invention relates to film type antennas and mobile communication terminals, and more particularly, to a film type antenna that has a contact structure to stably connect the film type antenna, formed integrally with a case of a mobile communication terminal, with a board inside the mobile communication terminal, and a mobile communication terminal using the film type antenna.

2. Description of the Related Art

Recently, mobile wireless terminals that separately use various kinds of bandwidths, such as CDMA, PDA, DCS, and GSM, or use all of the bandwidths, have come into widespread use. Terminals that have various kinds of functions and designs have appeared. As the terminals have gradually been reduced in size, thickness, and weight, the diversity of the functions of the terminals has attracted attention. Therefore, emphasis is placed on reducing the volume of the terminals while the terminals maintain the function of an antenna.

Particularly, in a case of an antenna, for example, a rod antenna or a helical antenna that protrudes from the outside of a terminal by a predetermined length has excellent characteristics because of omnidirectional radiation. However, the rod antenna or the helical antenna of the terminal is most susceptible to damage when it falls down, and reduces portability. Therefore, research has been conducted on an in-molding antenna that is formed integrally with a case of a mobile communication terminal.

### SUMMARY OF THE INVENTION

An aspect of the present invention provides a film type antenna that has a contact structure to stably connect the film type antenna, formed integrally with a case of a mobile communication terminal, with a circuit of a board inside the mobile communication terminal, and a mobile communication terminal having the film type antenna.

According to an aspect of the present invention, there is provided a film type antenna including: a carrier film; a conductive pattern provided on one surface of the carrier film; and a conductive buffer layer provided on one surface of the conductive pattern.

The conductive buffer layer may be provided at a contact area where the conductive pattern is connected to an external circuit.

The conductive buffer layer may be a conductive rubber.

The film type antenna may further include an adhesive layer provided between the conductive pattern and the conductive buffer layer.

The adhesive layer may be copper foil tape.

According to another aspect of the present invention, there is provided a mobile communication terminal including: a carrier film; a conductive pattern provided on one surface of the carrier film; a conductive buffer layer provided on one surface of the conductive pattern; and a housing provided integrally with the carrier film.

The conductive buffer layer may be provided at a contact area where the conductive pattern is connected to an external circuit.

The conductive buffer layer may be conductive rubber.

The mobile communication terminal may further include an adhesive layer provided between the conductive pattern and the conductive buffer layer.

The adhesive layer may be copper foil tape.

The conductive pattern may be provided between the carrier film and the housing.

The carrier film may be provided on an outer surface of the housing.

The conductive buffer layer may be provided between the conductive pattern and the housing.

The mobile communication terminal may further include a connector in contact with the conductive buffer layer.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a cross-sectional view illustrating a film type antenna according to an exemplary embodiment of the invention;

FIG. 2 is a cross-sectional view illustrating a film type antenna according to another exemplary embodiment of the invention;

FIG. 3 is a cross-sectional view illustrating a mobile communication terminal according to still another exemplary embodiment of the invention; and

FIG. 4 is a cross-sectional view illustrating a mobile communication terminal according to yet another exemplary embodiment of the invention.

### DETAILED DESCRIPTION OF THE PREFERRED EMBODIMENT

Exemplary embodiments of the present invention will now be described in detail with reference to the accompanying drawings.

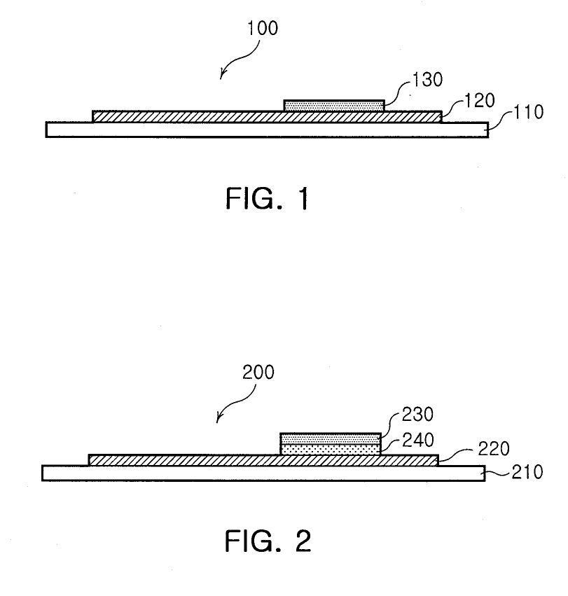

FIG. 1 is a cross-sectional view illustrating a film type antenna according to an exemplary embodiment of the invention.

Referring to FIG. 1, a film type antenna 100 according to an exemplary embodiment of the invention may include a carrier film 110, a conductive pattern 120, and a conductive buffer layer 130.

The carrier film 110 may be formed of a material that is appropriate to perform in-molding labeling (IML). Specifically, the carrier film 110 that has the conductive pattern 120 formed on one surface thereof is inserted into a mold for manufacturing a housing of a mobile communication terminal, synthetic resins used to form the housing of the mobile communication terminal are injected into the mold, and the housing are molded from the synthetic resins at the appropriate temperature and pressure. Therefore, the material that forms the carrier film 110 needs to be material that does not undergo significant deformation under the pressure and temperature during the in-molding labeling, and at the same time, can be formed integrally with the housing of the mobile communication terminal. In this embodiment, the carrier film 110 may include a thin, insulating polymer material.

The conductive pattern 120 may be an antenna pattern that is formed on one surface of the carrier film 110.

The conductive pattern 120 may be formed by using various kinds of methods. First, a conductive pattern may be printed onto the conductive ink carrier film 110 by using conductive ink. Alternatively, a desired pattern may be directly formed on the carrier film by sputtering or evaporation. The conductive pattern 120 may be a conductive pattern that is formed of previously manufactured metal foil which is then attached to the carrier film 110.

The conductive pattern 120 includes a power feed terminal, and may also include a connection terminal for providing an electrical connection to an external circuit, such as a ground terminal. In this embodiment, the power feed terminal may be a contact area where the conductive pattern is connected to an external power feed line.

The conductive buffer layer 130 may be formed at the contact area where the conductive pattern 120 can be connected to the external circuit. That is, the conductive buffer layer 130 may be formed over the area of the conductive pattern where the power feed terminal is formed.

In order to connect the conductive pattern 120 to a board, a connector may be used. The conductive buffer layer 130 is formed over an area where the connector is in contact with the conductive pattern. The conductive buffer layer 130 may serve as a buffer between the connector and the conductive pattern. The use of the conductive buffer layer 130 can improve contact stability between the connector and the conductive pattern.

The conductive buffer layer 130 may have conductivity since the conductive buffer layer 130 electrically connects the connector and the conductive pattern to each other. The conductive buffer layer 130 may be formed of a material having predetermined elasticity so as to improve the contact stability between the connector and the conductive pattern.

In this embodiment, the conductive buffer layer 130 may be conductive rubber. The conductive rubber features both conductivity and elasticity, making it suitable for use as the conductive buffer layer 130.

FIG. 2 is a cross-sectional view illustrating a film type antenna according to another exemplary embodiment of the invention.

Referring to FIG. 2, a film type antenna 200 according to this embodiment may include a carrier film 210, a conductive pattern 220, a conductive buffer layer 230, and an adhesive layer 240.

The carrier film 210 may be formed of a material that is appropriate to perform in-molding labeling (IML). Specifically, the carrier film 210 that has the conductive pattern 220 formed on one surface thereof is inserted into a mold for manufacturing a housing of a mobile communication terminal, synthetic resins used to form the housing of a mobile communication terminal are injected into the mold, and the housing is molded from the synthetic resins at the appropriate temperature and pressure. Therefore, the material that forms the carrier film 210 needs to be material that does not undergo significant deformation under the pressure and temperature during the in-molding labeling, and at the same time, can be formed integrally with the housing of the mobile communication terminal. In this embodiment, the carrier film 210 may include a thin, insulating polymer material.

The conductive pattern 220 may be an antenna pattern that is formed on the one surface of the carrier film 210.

The conductive pattern 220 may be formed by using various kinds of methods. A conductive pattern may be printed onto the carrier film 210 by using conductive ink. Alternatively, a desired pattern may be directly formed on the carrier film by sputtering or evaporation. The conductive pattern 220 may be a conductive pattern that is formed of previously manufactured metal foil which is then attached to the carrier film 210.

The conductive pattern 220 includes a power feed terminal, and may also include a connection terminal for providing an electrical connection to an external circuit, such as a ground terminal. In this embodiment, the power feed terminal may be a contact area where the conductive pattern is connected to an external power feed line.

The conductive buffer layer 230 may be formed over the contact area where the conductive pattern 220 can be connected to the external circuit. That is, the conductive buffer layer 230 may be formed at an area where the power feed terminal of the conductive pattern is formed.

A connector may be used to connect the conductive pattern 220 to a board. The conductive buffer layer 230 may be formed over the area where the connector is in contact with the conductive pattern. The conductive buffer layer 230 may serve as a buffer between the connector and the conductive pattern. The use of the conductive buffer layer 230 can improve contact stability between the connector and the conductive pattern.

The conductive buffer layer 230 may have conductivity since the conductive layer 230 electrically connects the connector and the conductive pattern to each other. Further, the conductive buffer layer 230 may have predetermined elasticity so as to improve the contact stability between the connector and the conductive pattern.

In this embodiment, the conductive buffer layer 230 may be conductive rubber. The conductive rubber features both conductivity and elasticity, making it suitable for use as the conductive buffer layer.

The adhesive layer 240 may be formed between the conductive pattern 220 and the conductive buffer layer 230. The adhesive layer 240 increases adhesive strength between the conductive pattern 220 and the conductive buffer layer 230, thereby preventing separation of the conductive buffer layer 230 from the conductive pattern 220 during the in-molding labeling.

In this embodiment, metal foil tape may be used as the adhesive layer 240.

When the metal foil tape is used, copper foil tape 240 may be applied to the conductive pattern 220, and the conductive rubber 230 may be applied to the copper foil tape. The copper foil tape has conductivity, and can strengthen the function of the conductive buffer layer 230.

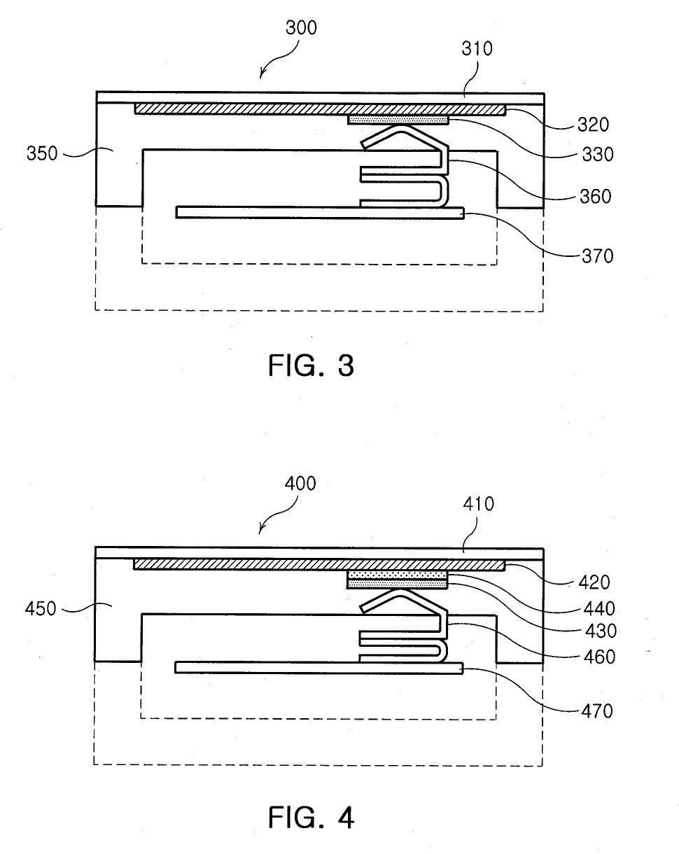

FIG. 3 is a cross-sectional view illustrating a mobile communication terminal according to still another exemplary embodiment of the invention.

Referring to FIG. 3, a mobile communication terminal 300 according to this embodiment may include a carrier film 310, a conductive pattern 320, a conductive buffer layer 330, and a housing 350 of the mobile communication terminal.

The carrier film 310 may be formed of a material that is appropriate to perform in-molding labeling (IML). Specifically, the carrier film 310 that has the conductive pattern 320 formed on one surface thereof is inserted into a mold for manufacturing the housing of the mobile communication terminal, synthetic resins used to form the housing of the mobile communication terminal are injected into the mold, and the housing is molded from the synthetic resins at the appropriate temperature and pressure. Therefore, the material that forms the carrier film 310 needs to be a material that does not undergo significant deformation under the pressure and temperature during the in-molding labeling, and at the same time, can be formed integrally with the housing of the mobile communication terminal. In this embodiment, the carrier film 310 may include a thin insulating polymer material.

The conductive pattern 320 may be an antenna pattern that is formed on one surface of the carrier film 310.

The conductive pattern 320 may be formed by using various kinds of methods. A conductive pattern may be printed onto the carrier film 310 by using conductive ink. Alternatively, a desired pattern may be directly formed on the carrier film by sputtering or evaporation. The conductive pattern 320 may be a conductive pattern that is formed of previously manufactured metal foil which is then attached to the carrier film 310.

The conductive pattern 320 includes a power feed terminal, and may also include a connection terminal for providing an electrical connection to an external circuit, such as a ground terminal. In this embodiment, the power feed terminal may be a contact area where the conductive pattern is connected to an external power feed line.

The conductive buffer layer 330 may be formed over the contact area where the conductive pattern 320 can be connected to the external circuit. That is, the conductive buffer layer 330 may be formed over the area where the power feed terminal of the conductive pattern is formed.

A connector may be used to connect the conductive pattern 320 to a board. The conductive buffer layer 330 is formed over the area where the connector is in contact with the conductive pattern. The conductive buffer layer 330 may serve as a buffer between the connector and the conductive pattern. The use of the buffer layer 330 can improve contact stability between the connector and the conductive pattern.

The conductive buffer layer 330 may have conductivity since the conductive buffer layer 330 electrically connects the connector and the conductive pattern to each other. Further, the conductive buffer layer 330 may have a material having predetermined elasticity so as to improve the contact stability between the connector and the conductive pattern.

In this embodiment, the conductive buffer layer 330 may be conductive rubber. The conductive rubber features both conductivity and elasticity, making it suitable for use as the conductive buffer layer.

The housing 350 of the mobile communication terminal may be manufactured by the in-molding labeling. That is, the carrier film that has the conductive pattern and the conductive buffer layer formed thereon is inserted into the mold for manufacturing the housing, and synthetic resins used to form the housing are injected into the mold, thereby manufacturing the housing. At this time, the carrier film 310 may be formed integrally with the housing 350, and be formed on the surface of the housing.

In this embodiment, the carrier film 310 may be formed on an outer surface of the housing 350. The conductive pattern 320 and the conductive buffer layer 330 may be formed between the housing 350 and the carrier film 310.

In this embodiment, the mobile communication terminal may further include a connector 360. The connector 360 may connect a board 370 with the conductive pattern 320 of the antenna that is formed on the surface of the housing 350 of the mobile communication terminal. The connector 360 may have predetermined elasticity.

The connector 360 may be fixed to the housing when the housing 350 of the mobile communication terminal is formed by the in-molding labeling.

Like this embodiment, when the conductive pattern 320 is formed on the outside of the housing 350 of the mobile communication terminal, and the connector 360 is used to connect the conductive pattern 320 to the board 370 inside the housing, the conductive pattern 320 on the surface of the housing may be deformed by the elasticity of the connector 360. In this embodiment, the conductive buffer layer 330 is formed over the area of the conductive pattern that is in contact with the connector, thereby reducing a physical force that is directly applied to the conductive pattern due to the elasticity of the connector 360.

FIG. 4 is a cross-sectional view illustrating a mobile communication terminal according to yet another exemplary embodiment of the invention.

Referring to FIG. 4, a mobile communication terminal 400 according to this embodiment may include a carrier film 410, a conductive pattern 420, a conductive buffer layer 430, an adhesive layer 440, and a housing 450 of the mobile communication terminal.

The carrier film 410 may be formed of a material that is appropriate to perform in-molding labeling (IML). Specifically, the carrier film 410 that has the conductive pattern 420 formed on one surface thereof is inserted into a mold for manufacturing the housing of the mobile communication terminal, synthetic resins used to form the housing of the mobile communication terminal are injected into the mold, and the housing is molded from the synthetic resins at the appropriate temperature and pressure. The material that forms the carrier film 410 needs to be a material that does not undergo significant deformation under the pressure and temperature during the in-molding labeling, and at the same time, can be formed integrally with the housing of the mobile communication terminal. In this embodiment, the carrier film 410 may include a thin insulating polymer material.

The conductive pattern 420 may be an antenna pattern that is formed on one surface of the carrier film 410.

The conductive pattern 420 may be formed by using various kinds of methods. First, a conductive pattern may be printed onto the carrier film 410 by using conductive ink. Alternatively, a desired pattern may be directly formed on the carrier film by sputtering or evaporation. The conductive pattern 420 may be a conductive pattern that is previously manufactured metal foil which is then attached to the carrier film 410.

The conductive pattern 420 includes a power feed terminal, and may also include a connection terminal for providing an electrical connection to an external circuit, such as a ground terminal. In this embodiment, the power feed terminal may be a contact area where the conductive pattern is connected to an external power feed line.

The conductive buffer layer 430 may be formed at the contact area where the conductive pattern 420 can be connected to the external circuit. That is, the conductive buffer layer 430 may be formed at the area where the power feed terminal of the conductive pattern is formed.

A connector may be used to connect the conductive pattern 420 to a board. The conductive buffer layer 430 is formed at the area where the connector is in contact with the conductive pattern. The conductive buffer layer 430 may serve as a buffer between the connector and the conductive pattern. The use of the buffer layer 430 can improve contact stability between the connector and the conductive pattern.

The conductive buffer layer 430 may have conductivity since the conductive buffer layer 430 electrically connects the connector and the conductive pattern to each other. Further, the conductive buffer layer 430 may be formed of a material having predetermined elasticity so as to improve the contact stability between the connector and the conductive pattern.

In this embodiment, the conductive buffer layer 430 may be conductive rubber. The conductive rubber features both conductivity and elasticity, making it suitable for use as the conductive buffer layer.

The adhesive layer 440 may be formed between the conductive pattern 420 and the conductive buffer layer 430. The adhesive layer 440 improves adhesive strength between the conductive pattern 420 and the conductive buffer layer 430, thereby preventing separation of the conductive buffer layer 430 from the conductive pattern 420 during the in-molding labeling.

In this embodiment, copper foil tape may be used as the adhesive layer 440.

When the copper foil tape is used, the copper foil tape 440 may be applied to the conductive pattern 420, and the conductive buffer layer 430 may be applied to the copper foil tape. The copper foil tape has conductivity, and can strengthen the function of the conductive buffer layer 430.

The housing 450 of the mobile communication terminal may be formed by the in-molding labeling. That is, the carrier film that has the conductive pattern and the conductive buffer layer formed thereon is inserted into the mold, and synthetic resins used to form the housing are injected into the mold, thereby manufacturing the housing. Here, the carrier film 410 may be formed integrally with the housing 450 and be formed on the surface of the housing.

In this embodiment, the carrier film 410 may be formed on an outer surface of the housing 450. The conductive pattern 420 and the conductive buffer layer 430 may be formed between the housing 450 and the carrier film 410.

In this embodiment, the mobile communication terminal may further include a connector 460. The connector 460 may connect a board 470 disposed inside the housing with the conductive pattern 420 of the antenna that is formed on the surface of the housing 450 of the mobile communication terminal. The connector 460 may have predetermined elasticity.

The connector 460 may be fixed to the housing when the housing 450 of the mobile communication terminal is formed by the in-molding labeling.

Like this embodiment, when the conductive pattern 420 is formed on the outside of the housing 450 of the mobile communication terminal, and the connector 460 is used to connect the conductive pattern 420 to the board 470 inside the housing, the conductive pattern 420 formed on the surface of the housing may be deformed due to the elasticity of the connector 460. In this embodiment, the conductive buffer layer 430 is formed over the area of the conductive pattern that is in contact with the connector, thereby reducing a physical force that is directly applied to the conductive pattern due to the elasticity of the connector.

As set forth above, according to exemplary embodiments of the invention, a film type antenna that has a contact structure to stably connect the film type antenna to a circuit of a board inside a mobile communication terminal, and a mobile communication terminal having the film type antenna.

While the present invention has been shown and described in connection with the exemplary embodiments, it will be apparent to those skilled in the art that modifications and variations can be made without departing from the spirit and scope of the invention as defined by the appended claims.

What is claimed is:

1. A film type antenna comprising:
a carrier film;
a conductive pattern provided on one surface of the carrier film; and
a conductive buffer layer provided on one surface of the conductive pattern.

2. The film type antenna of claim 1, wherein the conductive buffer layer is provided at a contact area where the conductive pattern is connected to an external circuit.

3. The film type antenna of claim 1, wherein the conductive buffer layer is conductive rubber.

4. The film type antenna of claim 1, further comprising an adhesive layer provided between the conductive pattern and the conductive buffer layer.

5. The film type antenna of claim 4, wherein the adhesive layer is copper foil tape.

6. A mobile communication terminal comprising:
a carrier film;
a conductive pattern provided on one surface of the carrier film;
a conductive buffer layer provided on one surface of the conductive pattern; and
a housing provided integrally with the carrier film.

7. The mobile communication terminal of claim 6, wherein the conductive buffer layer is provided at a contact area where the conductive pattern is connected to an external circuit.

8. The mobile communication terminal of claim 6, wherein the conductive buffer layer is conductive rubber.

9. The mobile communication terminal of claim 6, further comprising an adhesive layer provided between the conductive pattern and the conductive buffer layer.

10. The mobile communication terminal of claim 9, wherein the adhesive layer is copper foil tape.

11. The mobile communication terminal of claim 6, wherein the conductive pattern is provided between the carrier film and the housing.

12. The mobile communication terminal of claim 11, wherein the carrier film is provided on an outer surface of the housing.

13. The mobile communication terminal of claim 12, wherein the conductive buffer layer is provided between the conductive pattern and the housing.

14. The mobile communication terminal of claim 6, further comprising a connector in contact with the conductive buffer layer.
